(19) United States
(12) Patent Application Publication
(10) Pub. No.: US 2025/0171676 A1
(43) Pub. Date: May 29, 2025

(54) NON-AQUEOUS BASED COMPLETION FLUID COMPOSITION

(71) Applicant: PETRÓLEO BRASILEIRO S.A. – PETROBRAS, Rio de Janeiro (BR)

(72) Inventors: Walter Francisco Francisco CARDOSO JUNIOR, Rio de Janeiro (BR); Kaio GONZAGA, Vitória (BR); Angelo Marinho VIANNA, Rio de Janeiro (BR); Elessandre ALVES DE SOUZA, Rio de Janeiro (BR)

(73) Assignee: PETRÓLEO BRASILEIRO S.A. – PETROBRAS, Rio de Janeiro (BR)

(21) Appl. No.: 18/938,989

(22) Filed: Nov. 6, 2024

(30) Foreign Application Priority Data
Nov. 28, 2023 (BR) 1020230249396

(51) Int. Cl. C09K 8/36; C09K 8/03

(52) U.S. Cl. CPC C09K 8/36; C09K 8/032

(57) ABSTRACT

The present invention relates to a non-aqueous based completion fluid (NFBAC) composition comprising (a) a continuous phase comprising an internal olefin; (b) a primary emulsifier comprising a surfactant selected from amino fatty acids or fatty acid amides; (c) a secondary emulsifier comprising a surfactant selected from amino fatty acids or fatty acid amides; (d) a saponifier comprising calcium hydroxide; (e) an internal phase comprising a CaCl₂) brine; (f) optionally a viscosifier comprising an organophilic clay and a rheological modifier; and (g) optionally a thinning agent comprising a rheological modifier.

### CROSS-REFERENCES TO RELATED APPLICATIONS

This application claims the benefit of and priority to Brazilian patent application Ser. No. 1020230249396 filed on Nov. 28, 2023, the contents of which are hereby incorporated by reference in their entirety for all purposes.

### FIELD OF THE INVENTION

The present invention refers to the field of oil and gas exploration and production, more precisely in the area of well drilling and completion, and describes a non-aqueous based completion fluid composition comprising calcium chloride brine.

### BACKGROUND OF THE INVENTION

Completion fluids are used in the drilling of oil and gas wells in the final stage of wellbore drilling, performing functions related to the preparation of the well for production or injection of fluids. In particular, such functions include well cleaning, pressure control, prevention of formation damage, lubrication and cooling of equipment. Fluids generally consist of a mixture of water, polymers, and other chemical additives.

The main completion fluids can be water-based, oil-based, glycol-based or polymer-based. Water-based fluids are often used when the formation is compatible with water and comprise water, salts and polymers. In turn, oil-based fluids are less corrosive and therefore are used in situations where water-based fluids cannot be used.

Glycol-based fluids are used to prevent wellbore clogging resulting from the hydrates formation. Polymer-based fluids have different viscosity properties and allow the transport of solid particles.

Wells with large extensions of sandstones and shales in the same phase make drilling with water-based drilling fluids unfeasible. These wells require a non-aqueous based drilling fluid (NABF) to ensure the necessary inhibition to cross the clayey section and minimize formation damage in the sandstone reservoir. For example, there is a need for a completion fluid compatible with the completion process of wells with a “True One Trip 3 Phases” configuration, in which the drilling, casing installation and well cleaning steps occur continuously, that is, without interruptions. For greater compatibility and better performance, it is necessary to use a completion fluid that is also non-aqueous like the drilling fluid.

Drilling shales and sandstones in a single phase represents an excellent opportunity, as it reduces the construction costs of wells in sandstone reservoirs, increasing the return on invested capital or even enabling the exploration of some fields with a Technical and Economic Feasibility Study (TEFS) of less attractiveness. However, this configuration brings many challenges regarding the drilling and completion fluids to be used. In this well scenario, the ideal is to enable drilling of this last phase, containing shale and sandstone, using a water-based drilling fluid (WBDF), as this would allow the well completion to follow the procedures and use the fluids conventionally applied.

However, there are wells with a large extension of sandstones and shales in the same phase, wherein drilling with water-based drilling fluid (WBDF) would be unfeasible. In these cases, a non-aqueous based drilling fluid (NABDF) is required to ensure the necessary inhibition to cross the clayey section and minimize formation damage in the sandstone reservoir. Next, for greater compatibility and better performance, it is necessary to use a completion fluid being also non-aqueous.

In this sense, there is a need for a non-aqueous-based completion fluid (NABCF) composition that allows the construction of the well with this configuration.

### PRIOR ART

Some prior art documents deal with completion fluids, such as:

Patent document PI 9914352-6, entitled “Aditivo de fluido de perfuração e processo utilizando o mesmo”, discloses a composition comprising a polymer comprising repeating units derived from an unsaturated amide, an N-vinyl lactam and, optionally, a vinyl acid. Furthermore, said document discloses a water-based fluid composition, which can be used as a drilling fluid, comprising calcium chloride and a polymer. Furthermore, the composition disclosed in said document can be used as a cavity treatment, drilling, preparation or finishing fluid in oil field operations.

In particular, in the fluid composition disclosed in said document, the polymer and calcium chloride are each present in a ratio sufficient to achieve fluid loss control of the water-based fluid composition.

Although the fluid composition contains calcium chloride and its usage can also be in the well drilling and completing, the fluid is water-based and comprises a considerably different composition from the fluid developed in the present invention. Furthermore, the fluid disclosed in the aforementioned document would not be applicable to wells with a large extension of sandstones and shales in the same phase, and it is not related to the technical problem solved by the present invention.

In turn, patent document PI 0716793-8, entitled “Agentes de peso revestidos com dispersante”, reveals a method for formulating a drilling fluid as well as the composition of said fluid. Drilling fluid can be a water-based fluid, an oil-based fluid, or an invert emulsion. The fluid composition comprises (i) a base fluid and (ii) a dimensioned weight agent coated with a dispersant, the base fluid being a water-based fluid, an oil-based fluid or an invert emulsion. The weighting agent may be selected from the group consisting of barite, calcium carbonate, dolomite, ilmenite, hematite, olivine, siderite, manganese oxide and strontium sulfate and the dispersant may be selected from the group consisting of oleic acid, polybasic fatty acids, alkyl benzene sulfonic acids, alkane sulfonic acids, linear alpha-olefin sulfonic acid, alkaline earth metal salts thereof and phospholipids.

This invention (PI 0716793-8) focuses on one of the components of a formulation, a product that, when added to the fluid, would function as a thickening agent with specific characteristics. The present invention relates to a non-aqueous based fluid formulation developed to be used in well completion. Although both mention the expression “non-aqueous based fluid”, they deal with very different topics.

Patent document BR 11 2012 006473 8, entitled “Fluídos de emulsão inversa com fase interna de concentração elevada”, discloses a well invert emulsion fluid comprising (i) an outer oil phase, (ii) an inner non-oily phase wherein the ratio of the outer oil phase and the inner non-oily phase is less than 50:50 and (iii) a stabilizing emulsifier (alkoxylate ether acid) of the outer oil phase and the inner non-oily phase wherein an average diameter of the inner non-oily phase ranges from 0.5 to 5 μm. The alkoxylate ether acid being more specifically an alkoxylated fatty alcohol terminated with an acetic acid. And the invert emulsion fluid being used as a drilling fluid.

However, the fluid of said document does not comprise a viscosifier comprising a rheological modifier or a thinning agent comprising a rheological modifier. Furthermore, the fluid revealed in the document does not necessarily contain two emulsifiers. Furthermore, the emulsifiers used in the fluid revealed therein are different from aminated fatty acids and fatty acid amides. Furthermore, the non-aqueous fluid of the present invention was developed for bore completion in scenarios where, to ensure good performance, it is necessary to use a non-aqueous fluid in drilling shale and sandstone in the same phase.

Patent document BR 11 2017 001296 0, entitled “Fluidos à Base de Óleo Eletricamente Condutivos”, discloses a downhole fluid composition comprising (i) a petroleum-based fluid and (ii) at least one calcined petroleum coke in particulate form in an amount effective to improve the electrical conductivity of the downhole fluid. The downhole fluid may be a drilling fluid, a completion fluid, a penetration fluid, a stimulation fluid, or combinations thereof. The composition of the fluid may also include a surfactant.

Although the fluid disclosed is an oil-based fluid, its composition and purpose are different from the fluid developed in the present invention. For example, the fluid disclosed in said document comprises petroleum coke, and deals with its electrical conductivity property, unlike the fluid of the present invention.

In turn, patent document GB 2552198 A, entitled “Downhole composition comprising Group I or Group II metal salt”, refers to fluids for use in drilling wells to recover hydrocarbons such as oil and/or gas. More specifically, it refers to fluids for use during drilling, completion and workover operations.

The composition of the fluid disclosed in said document comprises an organic liquid selected from an alcohol, glycol and glycol ether having dissolved and/or suspended therein at least one metallic salt from Group I or Group II. The metal salt may be a halide, a carboxylate, or a carbonate of a Group I or Group II metal, such as sodium chloride, sodium bromide, potassium chloride, potassium bromide, magnesium chloride, calcium bromide, and mixtures thereof. The metal salt may also be a mixture of two or more Group I and/or Group II metal salts, such as sodium chloride/sodium bromide, cesium formate/potassium formate, or cesium formate/sodium formate.

The fluid disclosed in said document, unlike the present invention, does not comprise an emulsion comprising an olefin as a continuous phase and a CaCl₂ brine, but rather a solution or suspension of a Group I or II salt in alcohol, glycol or glycol ether.

Finally, patent document WO 2019/036287 A1, entitled “Oil-Based Drilling Fluid Compositions Which Include Layered Double Hydroxides as Rheology Modifiers”, reveals drilling fluid compositions, methods for producing drilling fluids, and methods for drilling underground wells using the drilling fluids. According to one embodiment, a drilling fluid composition may include an oil phase, an aqueous phase, and a rheology modifier. The rheology modifier may include a layered double hydroxide, such as Mg/Al-Myristate layered double hydroxide.

The fluid disclosed in said document has a different application from the fluid of the present invention, since it is a drilling fluid. Furthermore, the fluid disclosed in WO 2019/036287 A1 necessarily presents a layered double hydroxide, unlike the fluid of the present invention. This component is important for the rheological properties of the fluid revealed in the aforementioned document, which are not the same as those required for a completion fluid.

Thus, there is a need in the state of the art for the provision of a non-aqueous drilling fluid (NWDF) compatible with wells with a large extension of sandstones and shales in the same phase, ensuring the necessary inhibition to cross the clayey section and minimize formation damage in the sandstone reservoir.

### SUMMARY OF THE INVENTION

The present invention aims to propose a non-aqueous based completion fluid (NWBCF) composition comprising: (a) a continuous phase comprising an internal olefin; (b) a primary emulsifier comprising a surfactant selected from aminated fatty acids or fatty acid amides; (c) a secondary emulsifier comprising a surfactant selected from aminated fatty acids or fatty acid amides; (d) a saponifier comprising calcium hydroxide; (e) an internal phase comprising a CaCl₂ brine; (f) optionally a viscosifier comprising an organophilic clay and a rheological modifier; and (g) optionally a thinning agent comprising a rheological modifier.

### DETAILED DESCRIPTION OF THE INVENTION

The present invention relates to a non-aqueous based completion fluid (NWBCF) composition comprising: (a) a continuous phase comprising an internal olefin; (b) a primary emulsifier comprising a surfactant selected from amino fatty acids or fatty acid amides; (c) a secondary emulsifier comprising a surfactant selected from amino fatty acids or fatty acid amides; (d) a saponifier comprising calcium hydroxide; (e) an internal phase comprising a CaCl₂ brine; (f) optionally a viscosifier comprising an organophilic clay and a rheological modifier; and (g) optionally a thinning agent comprising a rheological modifier.

In a preferred embodiment, the internal olefin of the continuous phase is a linear chain C₁₄-C₁₈ olefin.

In a preferred embodiment, the thinning rheology modifier is an ethoxylated fatty acid.

In a preferred embodiment, the viscosifying organophilic clay is a sodium bentonite modified with quaternary ammonium salts.

In a preferred embodiment, the viscosifying rheological modifier is selected from polyamides, fatty acid polymers or combinations thereof. In an even more preferred embodiment, the viscosifying rheological modifier is a combination of polyamides and fatty acid polymers.

In a preferred embodiment, the saponifier comprising calcium hydroxide is hydrated lime.

In a preferred embodiment, the NABCF composition has a specific mass ranging from 1.006 kg/L to 1.198 kg/L (8.4 to 10 lb/gal). In an even more preferred embodiment, the NABCF composition has a specific mass ranging from 1.006 kg/L to 1.174 kg/L (8.4 to 9.8 lb/gal). In an even more preferred embodiment, the NABCF composition has a specific mass of 1.150 kg/L (9.6 lb/gal).

In a preferred embodiment, the oil and water ratio of the present invention NABCF composition ranges from 66:34 to 33:67, more preferably from 66:34 to 37:63.

In a preferred embodiment, the internal olefin is present at a concentration of 33% v/v to 62% v/v; the primary emulsifier is present at a concentration of 22.82 g/L to 34.24 g/L (8 to 12 lb/bbl); the secondary emulsifier is present at a concentration of 11.41 g/L to 22.82 g/L (4 to 8 lb/bbl); the saponifier comprising calcium hydroxide is present at a concentration of 22.82 g/L to 34.24 g/L (8 to 12 lb/bbl); the CaCl₂ is present at a concentration of 33% v/v to 67% v/v; the viscosifying organoclay is present at a concentration of 0 to 5.71 g/L (0 to 2 lb/bbl); the viscosifying rheological modifier is present at a concentration of 0 to 2.85 g/L (0 to 1 lb/bbl); and the thinning rheological modifier is present at a concentration of 0 to 8.56 g/L (0 to 3 lb/bbl).

In an even more preferred embodiment, the internal olefin is present in a ratio of 37% v/v; the primary emulsifier is present in a concentration of 28.53 g/L (10 lb/bbl); the secondary emulsifier is present in a concentration of 17.12 g/L (6 lb/bbl); the saponifier comprising calcium hydroxide is present in a concentration of 22.82 g/L (12 lb/bbl); the CaCl₂ brine is present at a concentration of 58% v/v; and the thinning rheological modifier is present at a concentration of 4.28 g/L (1.5 lb/bbl).

The NABCF compositions with calcium chloride of the present invention enable well drilling and completion in just 3 phases, significantly reducing the cost of well construction. Additionally, after operation, these fluids can be mixed with conventional non-aqueous drilling fluid inventory, simplifying the logistics process.

Additionally, since its composition is based on calcium chloride, the NABCF compositions of the present invention have a lower impact on the environment and health, compared to formulations containing calcium bromide commonly used for this purpose.

The NABCF composition of the present invention solves the technical problem related to the completion of wells with a large extension of sandstones and shales in the same phase, in which drilling with WBDFs is unfeasible. The design of wells that include drilling in three phases, with only the last one returning to the surface, in addition to the lowering of the completion set in a single maneuver, significantly reduces the total construction time of wells in the post-salt layer. The NABCF composition of the present invention enables the drilling of an extensive phase with the presence of shales and sandstones, ensuring chemical inhibition of clay formations, reduced damage to the reservoir and compatibility with the completion and stimulation stages.

The NABCF composition of the present invention can be prepared in one or more fluid tanks containing rotary agitators and shears. Preparation (or manufacturing, in usual field terminology) can be done on the drilling rig itself or at a fluid station, by adding each of the components, one by one and in the same order (from top to bottom) as stated in Table 1, maintaining constant agitation. If prepared at a fluid station, once ready, the fluid is transported to the probe by means of fluid carriers.

To demonstrate its potential, the present invention will be described in more detail in terms of realized examples. It should be noted that the following description is only intended to elucidate the understanding of the proposed invention and to reveal, in more detail, the embodiment of the invention without limiting it to the same. Thus, variables similar to the example are also within the scope of the invention.

### Example 1: Compositions of NABCF with CaCl₂

NABCF compositions with calcium chloride were developed, with weights ranging from 1.006 kg/L to 1.198 kg/L (8.4 and 10 lb/gal), as detailed in Table 1 below.

TABLE 1
Compositions of NABCF with CaCl₂

| | | Composition of NABCF | | | | | | | | |
|---|---|---|---|---|---|---|---|---|---|---|
| | | 1 | 2 | 3 | 4 | 5 | 6 | 7 | 8 | 9 |
| ROA (%) | | 66/34 | 62/38 | 58/42 | 54/46 | 50/50 | 45/55 | 40/60 | 37/63 | 33/67 |
| Specific Mass | kg/L | 1.006 | 1.030 | 1.054 | 1.078 | 1.102 | 1.126 | 1.150 | 1.174 | 1.198 |
| | (lb/gal) | (8.4 | (8.6 | (8.8 | (9.0 | (9.2 | (9.4 | (9.6 | (9.8 | (10 |
| | | lb/gal) | lb/gal) | lb/gal) | lb/gal) | lb/gal) | lb/gal) | lb/gal) | lb/gal) | lb/gal) |
| Linear Chain C₁₄-W₁₈ Internal | | 0.62 | 0.58 | 0.54 | 0.5 | 0.46 | 0.42 | 0.37 | 0.34 | 0.3 |
| Olefin - Continuous phase (bbl/bbl) | | | | | | | | | | |
| aminated fatty acids - | g/L | 28.53 | 28.53 | 28.53 | 28.53 | 28.53 | 28.53 | 28.53 | 28.53 | 28.53 |
| Primary Emulsifier | (lb/bbl) | (10 | (10 | (10 | (10 | (10 | (10 | (10 | (10 | (10 |
| | | lb/bbl) | lb/bbl) | lb/bbl) | lb/bbl) | lb/bbl) | lb/bbl) | lb/bbl) | lb/bbl) | lb/bbl) |
| Fatty Acid Amides - | g/L | 17.12 | 17.12 | 17.12 | 17.12 | 17.12 | 17.12 | 17.12 | 17.12 | 17.12 |
| Secondary Emulsifier | (lb/bbl) | (6 | (6 | (6 | (6 | (6 | (6 | (6 | (6 | (6 |
| | | lb/bbl) | lb/bbl) | lb/bbl) | lb/bbl) | lb/bbl) | lb/bbl) | lb/bbl) | lb/bbl) | lb/bbl) |
| Hydrated lime - Saponifier | g/L | 34.24 | 34.24 | 34.24 | 34.24 | 34.24 | 34.24 | 34.24 | 34.24 | 34.24 |
| | (lb/bbl) | (12 | (12 | (12 | (12 | (12 | (12 | (12 | (12 | (12 |
| | | 1b/bbl) | 1b/bbl) | 1b/bbl) | 1b/bbl) | 1b/bbl) | 1b/bbl) | 1b/bbl) | 1b/bbl) | 1b/bbl) |
| CaCl₂ brine - Internal phase (bbl/bbl) | | 0.33 | 0.37 | 0.41 | 0.45 | 0.49 | 0.53 | 0.58 | 0.61 | 0.65 |
| Ethoxylated Fatty Acids - | g/L | — | — | — | — | 2.85 | 2.85 | 4.28 | 5.71 | 8.56 |
| Thinning Agent | (lb/bbl) | | | | | (1 | (1 | (1.5 | (2 | (3 |
| | | | | | | lb/bbl) | lb/bbl) | lb/bbl) | lb/bbl) | lb/bbl) |

The compositions were prepared experimentally on a laboratory bench, using a Silverson L5M-A mixer (or agitator), and by adding each of the components, one by one, in the same order (from top to bottom) as stated in table 1, maintaining constant agitation.

In this study, we sought to find NABCF compositions that were stable enough to be positioned in the well and allow the lower completion and production string to be lowered in a single maneuver (“True One Trip”), for a period that can vary from 5 to 10 days without the NABCF inverse emulsion losing its stability. Furthermore, it is important that the viscosity of the NABCF does not prevent its movement to the well due to problems with pump cavitation or high pumping pressure. Thus, the ideal NABCF would be a solids-free composition with high stability and controlled rheological properties.

However, the results of laboratory tests (detailed in the examples below) have shown that stability and rheological properties are directly proportional, i.e., the greater the stability, the greater the rheological properties will also be. The challenge was to find a balance point between these parameters, which is not so critical for compositions with weight between 0.959 kg/L (8.0 lb/gal) and 1.102 kg/L (9.2 lb/gal), where the oil/water ratio (OWR) reaches maximum values of 50/50. However, for weights greater than 1.102 kg/L (9.2 lb/gal) the OWR is inverted, with a smaller fraction of the continuous oil phase emulsifying a larger fraction of calcium chloride brine. For these compositions, stability is not a problem, since the compositions are very stable, however, as a consequence, they present a high viscosity. The study presented promising results for formulations weighing up to 1.174 kg/L (9.8 lb/gal).

### Example 2: Rheological Readings of NABCF Compositions

After preparing the compositions as described in Example 1, all NABCF compositions were aged in a rotary oven for 16 h at 65° C., before being taken to the viscometer FANN 35 A for readings.

TABLE 2
Rheological Readings of NABCF Compositions at 25° C., 65° C. and 82° C.

| | | Composition of NABCF | | | | | | | | | | | | | | |
|---|---|---|---|---|---|---|---|---|---|---|---|---|---|---|---|---|
| | | 1 | | | 2 | | | 3 | | | 4 | | | 5 | | |
| | | Viscometer FANN 35 A Readings | | | | | | | | | | | | | | |
| | | 25° | 65° | 82° | 25° | 65° | 82° | 25° | 65° | 82° | 25° | 65° | 82° | 25° | 65° | 82° |
| | | C. | C. | C. | C. | C. | C. | C. | C. | C. | C. | C. | C. | C. | C. | C. |
| 600 | rpm | 36 | 17 | 14 | 57 | 20 | 15 | 62 | 25 | 17 | 79 | 34 | 25 | 108 | 51 | 31 |
| 300 | rpm | 20 | 10 | 9 | 26 | 11 | 9 | 35 | 14 | 10 | 46 | 19 | 14 | 65 | 29 | 21 |
| 200 | rpm | 14 | 8 | 7 | 18 | 8 | 7 | 25 | 11 | 8 | 34 | 14 | 11 | 48 | 20 | 16 |
| 100 | rpm | 8 | 4 | 4 | 10 | 5 | 4 | 14 | 7 | 5 | 20 | 9 | 7 | 38 | 12 | 10 |
| 6 | rpm | 3 | 2 | 2 | 3 | 2 | 2 | 4 | 3 | 2 | 5 | 3 | 3 | 5 | 4 | 3 |
| 3 | rpm | 2 | 1 | 1 | 2 | 1 | 1 | 3 | 2 | 1 | 4 | 4 | 2 | 4 | 3 | 2 |

| | | | | | | | | | | | | | | | |
|---|---|---|---|---|---|---|---|---|---|---|---|---|---|---|---|
| gel 10 s | 4 | 2 | 2 | 4 | 2 | 2 | 5 | 4 | 3 | 5 | 3 | 1 | 6 | 5 | 4 |
| gel 30 s | 4 | 2 | 3 | 5 | 3 | 3 | 6 | 5 | 4 | 7 | 6 | 3 | 7 | 6 | 5 |

| | | Composition of NABCF | | | | | | | | | | | | | | |
|---|---|---|---|---|---|---|---|---|---|---|---|---|---|---|---|---|
| | | 6 | | | 7 | | | 8 | | | 9 | | | — | | |
| | | Viscometer FANN 35 A Readings | | | | | | | | | | | | | | |
| | | 25° | 65° | 82° | 25° | | | | 65° | 82° | 25° | 65° | 82° | | | |
| | | C. | C. | C. | C. | — | — | — | C. | C. | C. | C. | C. | — | — | — |
| 600 | rpm | 99 | 40 | 29 | 211 | — | — | — | 122 | 85 | >300 | 257 | 189 | — | — | — |
| 300 | rpm | 58 | 22 | 17 | 134 | 54 | 40 | 185 | 73 | 51 | >300 | 177 | 125 | — | — | — |
| 200 | rpm | 42 | 16 | 12 | 101 | 39 | 29 | 141 | 54 | 37 | >300 | 136 | 98 | — | — | — |
| 100 | rpm | 24 | 10 | 8 | 61 | 24 | 18 | 89 | 33 | 23 | 22 | 92 | 65 | — | — | — |
| 6 | rpm | 3 | 5 | 3 | 9 | 6 | 5 | 15 | 7 | 6 | 64 | 23 | 15 | — | — | — |
| 3 | rpm | 2 | 2 | 2 | 7 | 4 | 4 | 11 | 6 | 5 | 51 | 19 | 12 | — | — | — |

| | | | | | | | | | | | | | | | |
|---|---|---|---|---|---|---|---|---|---|---|---|---|---|---|---|
| gel 10 s | 5 | 4 | 3 | 8 | 5 | 5 | 11 | 6 | 6 | 49 | 18 | 12 | — | — | — |
| gel 30 s | 6 | 5 | 4 | 9 | 6 | 6 | 12 | 7 | 7 | 51 | 20 | 15 | — | — | — |

### Example 3: Rheological Stability Test of NABCF Compositions

After preparing the compositions as described in Example 1, all NABCF compositions were aged in a rotary oven for 16 h at 65° C., before performing the 1st reading (1 day). They were then kept static in an oven for 30 days, for a second reading (30 days) to verify the stability of their rheological properties. Readings were taken at 65° C.

TABLE 3
Rheological Stability Readings of NABCF Compositions at 65° C.

| | | Composition of NABCF | | | | | | | | | |
|---|---|---|---|---|---|---|---|---|---|---|---|
| | | 1 | | 2 | | 3 | | 4 | | 5 | |
| | | Viscometer FANN 35 A Readings | | | | | | | | | |
| | | 1 | 30 | 1 | 30 | 1 | 30 | 1 | 30 | 1 | 30 |
| | | day | days | day | days | day | days | day | days | day | days |
| 600 | rpm | 17 | 20 | 20 | 21 | 25 | 29 | 34 | 41 | 51 | 59 |
| 300 | rpm | 10 | 12 | 11 | 12 | 14 | 17 | 19 | 25 | 29 | 33 |
| 200 | rpm | 8 | 9 | 8 | 9 | 11 | 13 | 14 | 19 | 20 | 24 |
| 100 | rpm | 4 | 7 | 5 | 7 | 7 | 9 | 9 | 13 | 12 | 15 |
| 6 | rpm | 2 | 3 | 2 | 3 | 3 | 4 | 3 | 5 | 4 | 4 |
| 3 | rpm | 1 | 2 | 1 | 2 | 2 | 3 | 4 | 4 | 3 | 3 |

| | | | | | | | | | | |
|---|---|---|---|---|---|---|---|---|---|---|
| gel 10 s | 2 | 4 | 2 | 3 | 4 | 4 | 3 | 7 | 5 | 4 |
| gel 30 s | 2 | 6 | 3 | 4 | 5 | 5 | 6 | 8 | 6 | 5 |

| | | Composition of NABCF | | | | | | | | | |
|---|---|---|---|---|---|---|---|---|---|---|---|
| | | 6 | | 7 | | 8 | | 9 | | — | |
| | | Viscometer FANN 35 A Readings | | | | | | | | | |
| | | 1 | 30 | 1 | 30 | 1 | 30 | 1 | 30 | | |
| | | day | days | day | days | day | days | day | days | — | — |
| 600 | rpm | 40 | 45 | 91 | 99 | 122 | 134 | 257 | 178 | — | — |
| 300 | rpm | 22 | 26 | 54 | 57 | 73 | 80 | 177 | 110 | — | — |
| 200 | rpm | 16 | 19 | 39 | 41 | 54 | 59 | 136 | 83 | — | — |
| 100 | rpm | 10 | 12 | 24 | 24 | 33 | 39 | 92 | 51 | — | — |
| 6 | rpm | 5 | 4 | 6 | 5 | 7 | 6 | 23 | 9 | — | — |
| 3 | rpm | 2 | 3 | 4 | 4 | 6 | 4 | 19 | 7 | — | — |

| | | | | | | | | | | |
|---|---|---|---|---|---|---|---|---|---|---|
| gel 10 s | 4 | 4 | 5 | 5 | 6 | 5 | 18 | 8 | — | — |
| gel 30 s | 5 | 5 | 6 | 6 | 7 | 6 | 20 | 9 | — | — |

### Example 4: Micelle Decantation Test of NABCF Compositions

After preparing the NABCF compositions as described in Example 1 and aging it in a rotary oven for 16 h at 65° C., aliquots of the NABCF compositions were placed in graduated cylinders and kept static in an oven at three different temperatures (25° C., 65° C. and 82° C.) to verify the volume of supernatant olefin and evaluate the micelle decantation rate. The experiment mimics situations in which the fluid would remain static for a long time inside the well.

TABLE 4
Supernatant Olefin Percentage Readings (Micelle Decantation)

| | | Composition of NABCF | | | | | | | | | | | | | | |
|---|---|---|---|---|---|---|---|---|---|---|---|---|---|---|---|---|
| | | 1 | | | 2 | | | 3 | | | 4 | | | 5 | | |
| | | Supernatant Olefin Readings % | | | | | | | | | | | | | | |
| | | 25° | 65° | 82° | 25° | 65° | 82° | 25° | 65° | 82° | 25° | 65° | 82° | 25° | 65° | 82° |
| | | C. | C. | C. | C. | C. | C. | C. | C. | C. | C. | C. | C. | C. | C. | C. |
| 5 | days | 40% | 52% | 56% | 38% | 48% | 52% | 28% | 36% | 42% | 20% | 30% | 36% | 2% | 4% | 24% |
| 10 | days | 46% | 52% | 56% | 44% | 48% | 52% | 32% | 40% | 46% | 24% | 34% | 38% | 4% | 12% | 30% |
| 15 | days | 50% | 52% | 56% | 46% | 50% | 52% | 36% | 44% | 46% | 28% | 36% | 40% | 4% | 16% | 34% |
| 20 | days | 50% | 54% | 62% | 48% | 52% | 58% | 38% | 44% | 46% | 30% | 38% | 40% | 8% | 18% | 34% |
| 25 | days | 52% | 54% | 62% | 48% | 52% | 58% | 38% | 44% | 46% | 30% | 38% | 42% | 8% | 22% | 34% |
| 30 | days | 52% | 54% | 62% | 48% | 52% | 58% | 40% | 44% | 46% | 32% | 38% | 42% | 10% | 26% | 36% |

| | | Composition of NABCF | | | | | | | | | | | | | | |
|---|---|---|---|---|---|---|---|---|---|---|---|---|---|---|---|---|
| | | 6 | | | 7 | | | 8 | | | 9 | | | — | | |
| | | Supernatant Olefin Readings % | | | | | | | | | | | | | | |
| | | 25° | 65° | 82° | 25° | 65° | 82° | 25° | 65° | 82° | 25° | 65° | 82° | | | |
| | | C. | C. | C. | C. | C. | C. | C. | C. | C. | C. | C. | C. | — | — | — |
| 5 | days | 2% | 4% | 14% | 2% | 2% | 6% | 0 | 2% | 4% | 0 | 0 | 2% | — | — | — |
| 10 | days | 2% | 6% | 22% | 2% | 2% | 8% | 0 | 2% | 4% | 0 | 0 | 2% | — | — | — |
| 15 | days | 4% | 10% | 26% | 2% | 6% | 12% | 2% | 2% | 8% | 0 | 2% | 2% | — | — | — |
| 20 | days | 6% | 14% | 26% | 2% | 6% | 16% | 2% | 2% | 10% | 0 | 2% | 2% | — | — | — |
| 25 | days | 6% | 14% | 28% | 2% | 8% | 18% | 2% | 4% | 12% | 0 | 2% | 2% | — | — | — |
| 30 | days | 8% | 18% | 30% | 4% | 8% | 20% | 2% | 4% | 14% | 0 | 2% | 4% | — | — | — |

1. A non-aqueous based completion fluid (NACF) composition, comprising:
a) a continuous phase comprising an internal olefin;
b) a primary emulsifier comprising a surfactant selected from aminated fatty acids or fatty acid amides;
c) a secondary emulsifier comprising a surfactant selected from aminated fatty acids or fatty acid amides;
d) a saponifier comprising calcium hydroxide;
e) an internal phase comprising a CaCl2 brine;
f) optionally a viscosifier comprising an organophilic clay and a rheological modifier; and
g) optionally, a thinning agent comprising a rheological modifier.

2. The non-aqueous based completion fluid composition of claim 1, wherein the internal olefin of the continuous phase is a linear chain C14-C18 olefin.

3. The non-aqueous completion fluid composition of claim 1, wherein the thinning rheological modifier is an ethoxylated fatty acid.

4. The non-aqueous based completion fluid composition of claim 1, wherein the viscosifying organophilic clay is a sodium bentonite modified with quaternary ammonium salts.

5. The non-aqueous based completion fluid composition of claim 1, wherein the viscosifying rheological modifier is selected from polyamides, fatty acid polymers and their combinations.

6. The non-aqueous based completion fluid composition of claim 1, wherein the saponifier comprising calcium hydroxide is hydrated lime.

7. The non-aqueous based completion fluid composition of claim 1, characterized in that it has a specific mass ranging from 1.006 kg/L to 1.198 kg/L (8.4 to 10 lb/gal).

8. The non-aqueous based completion fluid composition of claim 7, characterized in that it has a specific mass of 1.150 kg/L (9.6 lb/gal).

9. The non-aqueous based completion fluid composition of claim 1, wherein the oil and water ratio of the NACF composition ranges from 66:34 to 33:67.

10. The non-aqueous based completion fluid composition of claim 9, wherein the oil and water ratio of the NACF composition is preferably 66:34 to 37:63.

11. The non-aqueous based completion fluid composition, according claim 1, characterized in that the internal olefin is present at a concentration of 33% v/v to 62% v/v; the primary emulsifier is present at a concentration of 22.82 g/L to 34.24 g/L (8 to 12 lb/bbl); the secondary emulsifier is present at a concentration of 11.41 g/L to 22.82 g/L (4 to 8 lb/bbl); the saponifier comprising calcium hydroxide is present at a concentration of 22.82 g/L to 34.24 g/L (8 to 12 lb/bbl); the CaCl2 brine is present at a concentration of 33% v/v to 67% v/v; the viscosifying organoclay is present at a concentration of 0 to 5.71 g/L (0 to 2 lb/bbl); the viscosifying rheological modifier is present at a concentration of 0 to 2.85 g/L (0 to 1 lb/bbl); and the thinning rheological modifier is present at a concentration of 0 to 8.56 g/L (0 to 3 lb/bbl).

12. The non-aqueous based completion fluid composition of claim 11, wherein the internal olefin is present at a concentration of 37% v/v; the primary emulsifier is present at a concentration of 28.53 g/L (10 lb/bbl); the secondary emulsifier is present at a concentration of 17.12 g/L (6 lb/bbl); the saponifier comprising calcium hydroxide is present at a concentration of 22.82 g/L (12 lb/bbl); the CaCl2 brine is present at a concentration of 58% v/v; and the thinning rheological modifier is present at a concentration of 4.28 g/L (1.5 lb/bbl).
